(19) United States
(12) Patent Application Publication
(10) Pub. No.: US 2025/0208291 A1
(43) Pub. Date: Jun. 26, 2025

(54) TECHNIQUES TO COMPENSATE FOR PHASE IMPAIRMENTS IN LIDAR SYSTEMS

(71) Applicant: Aeva, Inc., Mountain View, CA (US)

(72) Inventors: Shirish Ashok Altekar, Palo Alto, CA (US); Kumar Bhargav Viswanatha, Santa Clara, CA (US); Behsan Behzadi, Sunnyvale, CA (US); Mina Rezk, Haymarket, VA (US)

(21) Appl. No.: 18/759,053

(22) Filed: Jun. 28, 2024

Related U.S. Application Data
(60) Provisional application No. 63/613,050, filed on Dec. 20, 2023.

(51) Int. Cl. G01S 17/34; G01S 7/481; G01S 7/497

(52) U.S. Cl. CPC G01S 17/34; G01S 7/4811; G01S 7/4818; G01S 7/497

(57) ABSTRACT

A light detection and ranging (LiDAR) system that includes an optical arrangement to emit an outgoing optical beam towards a target and collect light returned from the target in a target optical beam. The system also includes an optical splitter to redirect a portion of the outgoing optical beam to an optical delay device to generate a reference optical beam. The system also includes a first optical receiver to generate a target signal, and a second optical receiver to generate a reference signal. The system also includes a signal processing system to process the reference signal to generate a phase noise estimate, combine the phase noise estimate with the target signal in a digital time-domain computation to eliminate noise in the target signal to generate a phase corrected target signal, and determine a range of the target from the phase corrected target signal.

### RELATED APPLICATIONS

This application claims priority from and the benefit of U.S. Provisional Patent Application No. 63/613,050 filed on Dec. 20, 2023, the entire contents of which are incorporated herein by reference in their entirety.

### FIELD OF INVENTION

The present disclosure is related to light detection and ranging (LIDAR) systems.

### BACKGROUND

Conventional Frequency-Modulated Continuous-Wave (FMCW) LIDAR systems include several possible phase impairments such as laser phase noise, circuitry phase noise, flicker noise that the driving electronics inject on a laser, drift over temperature/weather, and chirp rate offsets. These impairments cause loss in probability of detection, increase false alarm and range/velocity bias, and increase the error in estimated target range/velocity.

### BRIEF DESCRIPTION OF THE DRAWINGS

For a more complete understanding of the various examples, reference is now made to the following detailed description taken in connection with the accompanying drawings in which like identifiers correspond to like elements.

FIG. 1 illustrates a LIDAR system according to example implementations of the present disclosure.

FIG. 2 is a time-frequency diagram of an FMCW scanning signal that can be used by a LIDAR system to scan a target environment according to some embodiments.

FIG. 3 is a block diagram of an example LIDAR system with phase noise correction, according to embodiments of the disclosure.

FIG. 4 is a block diagram showing an example of a phase noise correction unit, according to embodiments of the disclosure.

FIG. 5 is a block diagram showing another example of a phase noise correction unit, according to embodiments of the disclosure.

FIG. 6 is a block diagram showing another example of a phase noise correction unit, according to embodiments of the disclosure.

FIG. 7 is a process flow diagram summarizing a method for eliminating phase noise from signals used to measure range, according to an embodiment of the present disclosure.

### DETAILED DESCRIPTION

The present disclosure describes various examples of LIDAR systems and methods that, among other things, add a reference channel to the system that measures a portion of the outgoing optical signal that is redirected by one or more splitters, generate an estimate of the phase impairments in the outgoing optical beam based on the reference channel, and correct the phase impairments in the measured return signals based on the estimated phase impairment. Thus, embodiments of the present invention include the functionality to estimate phase impairments and to compensate for them in the return signal. Such impairments may be caused, for example, by laser phase noise, circuitry phase noise, flicker noise, drift over temperature or weather, chirp rate offsets, and other types of impairments that can cause a loss in probability of detection, increase false alarm, and lead to mis-estimation of range or velocity that can lead to bias in range/velocity and increased range/velocity error. Phase impairments may also be referred to herein as phase noise.

An example method to correct phase impairments in a LIDAR system includes emitting an outgoing optical beam towards a target and collecting light returned from the target in a target optical beam; redirecting a portion of the outgoing optical beam to an optical delay device to generate a reference optical beam; detecting a first beat frequency from the target optical beam to generate a target signal, and detecting a second beat frequency from the reference optical beam to generate a reference signal; processing the reference signal to generate a phase noise estimate; combining the phase noise estimate with the target signal in a digital time-domain computation to eliminate noise in the target signal to generate a phase corrected target signal; and determining a range of the target from the phase corrected target signal.

According to some embodiments, the described LIDAR system may be implemented in any sensing market, such as, but not limited to, transportation, manufacturing, metrology, medical, and security systems. According to some embodiments, the described LIDAR system is implemented as a FMCW device that assists with spatial awareness for automated driver assist systems, or self-driving vehicles.

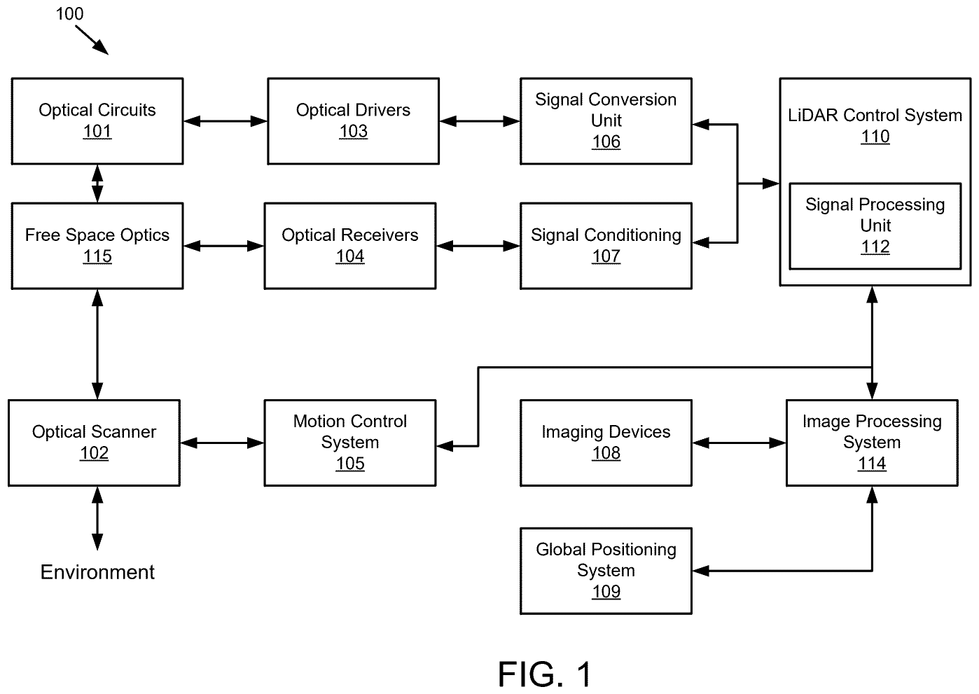

FIG. 1 illustrates a LIDAR system 100 according to example implementations of the present disclosure. The LIDAR system 100 includes one or more of each of a number of components, but may include fewer or additional components than shown in FIG. 1. As shown, the LIDAR system 100 includes optical circuits 101 implemented on a photonics chip. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS. The free space optics 115 may further include a diffractive element to deflect optical beams having different frequencies at different angles along an axis (e.g., a fast-axis).

In some examples, the LIDAR system 100 includes an optical scanner 102 that includes one or more scanning mirrors that are rotatable along an axis (e.g., a slow-axis) that is orthogonal or substantially orthogonal to the fast-axis of the diffractive element to steer optical signals to scan an environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coated window or the like.

To control and support the optical circuits 101 and optical scanner 102, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LIDAR control systems 110 may include a signal processing unit 112 such as a DSP. The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LIDAR control systems 110 are also configured to output digital control signals for the optical scanner 102. A motion control system 105 may control the galvanometers of the optical scanner 102 based on control signals received from the LIDAR control systems 110. For example, a digital-to-analog converter may convert coordinate routing information from the LIDAR control systems 110 to signals interpretable by the galvanometers in the optical scanner 102. In some examples, a motion control system 105 may also return information to the LIDAR control systems 110 about the position or operation of components of the optical scanner 102. For example, an analog-to-digital converter may in turn convert information about the galvanometers' position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location, and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long range measurements of range, velocity, azimuth, and elevation of the surrounding environment.

In some examples, the scanning process begins with the optical drivers 103 and LIDAR control systems 110. The LIDAR control systems 110 instruct the optical drivers 103 to independently modulate one or more optical beams, and these modulated signals propagate through the passive optical circuit to the collimator. The collimator directs the light at the optical scanning system that scans the environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from the environment pass through the optical circuits 101 to the receivers. Because the polarization of the light has been transformed, it may be reflected by a polarization beam splitter along with the portion of polarized light that was reflected back to the optical circuits 101. Accordingly, rather than returning to the same fiber or waveguide as an optical source, the reflected light is reflected to separate optical receivers. These signals interfere with one another and generate a combined signal. Each beam signal that returns from the target produces a time-shifted waveform. The temporal phase difference between the two waveforms generates a beat frequency measured on the optical receivers (photodetectors). The combined signal can then be reflected to the optical receivers 104.

The analog signals from the optical receivers 104 are converted to digital signals using ADCs. The digital signals are then sent to the LIDAR control systems 110. A signal processing unit 112 may then receive the digital signals and interpret them. In some embodiments, the signal processing unit 112 also receives position data from the motion control system 105 and galvanometers (not shown) as well as image data from the image processing system 114. The signal processing unit 112 can then generate a 3D point cloud with information about range and velocity of points in the environment as the optical scanner 102 scans additional points. The signal processing unit 112 can also overlay a 3D point cloud data with the image data to determine velocity and distance of objects in the surrounding area. The system may also process the satellite-based navigation location data to provide a precise global location.

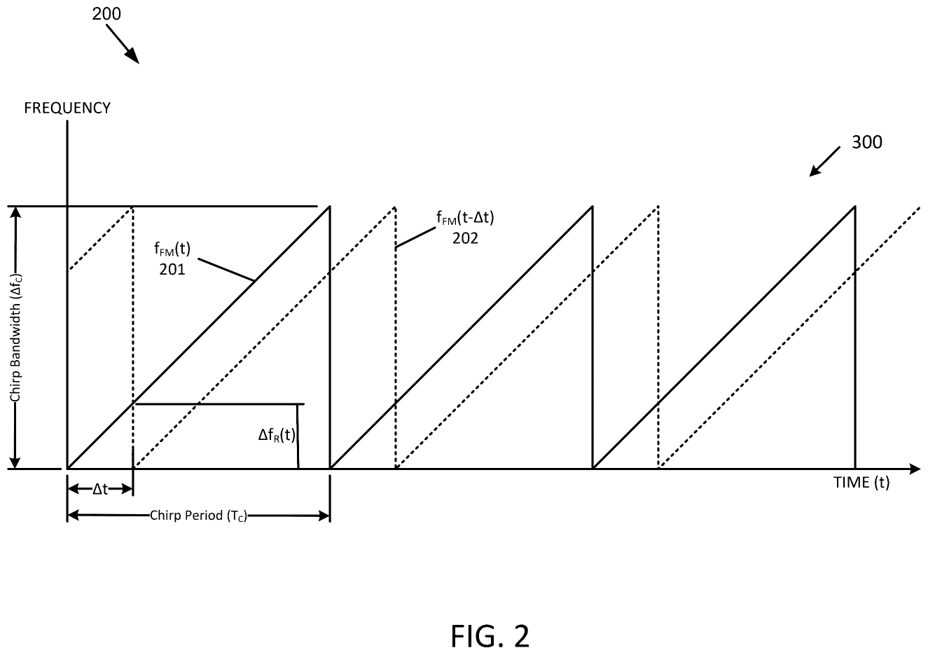

FIG. 2 is a time-frequency diagram 200 of an FMCW scanning signal 201 that can be used by a LIDAR system, such as system 100, to scan a target environment according to some embodiments. In one example, the scanning waveform 201 is a sawtooth waveform (sawtooth “chirp”) with a chirp bandwidth Δf_{C}, a chirp period T_{C}, and a frequency f_{FM}(t). The slope of the sawtooth is given as α=(Δf_{C}/T_{C}). FIG. 2 also depicts target return signal 202 according to some embodiments. Target return signal 202, labeled as f_{FM} (t−Δt), is a time-delayed version of the scanning signal 201, where Δt is the round trip time to and from a target illuminated by scanning signal 201. The round trip time is given as Δt=2R/v, where R is the target range and v is the velocity of the optical beam, which is the speed of light c. The target range, R, can therefore be calculated as R=c(Δt/2). When the return signal 202 is optically mixed with the scanning signal, a range dependent difference frequency (“beat frequency”) Δf_{R} (t) is generated. The beat frequency Δf_{R} (t) is linearly related to the time delay Δt by the slope of the sawtooth, a. That is, Δf_{R} (t)=αΔt. Since the target range R is proportional to Δt, the target range R can be calculated as R=(c/2) (Δf_{R} (t)/a). That is, the range R is linearly related to the beat frequency Δf_{R} (t). The beat frequency Δf_{R} (t) can be generated, for example, as an analog signal in optical receivers 104 of system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in system 100.

It should be noted that the target return signal 202 will, in general, also include a frequency offset (Doppler shift) if the target has a velocity relative to the LIDAR system 100. The Doppler shift can be determined separately, and used to correct the frequency of the return signal, so the Doppler shift is not shown in FIG. 2 for simplicity and ease of explanation. It should also be noted that the sampling frequency of the ADC will determine the highest beat frequency that can be processed by the system without aliasing. In general, the highest frequency that can be processed is one-half of the sampling frequency (i.e., the “Nyquist limit”). In one example, and without limitation, if the sampling frequency of the ADC is 1 gigahertz, then the highest beat frequency that can be processed without aliasing (Δf_{R}max) is 500 megahertz. This limit in turn determines the maximum range of the system as Rmax=(c/2)(Δf_{R}max/α) which can be adjusted by changing the chirp slope a. In one example, while the data samples from the ADC may be continuous, the subsequent digital processing described below may be partitioned into “time segments” that can be associated with some periodicity in the LIDAR system 100. In one example, and without limitation, a time segment might correspond to a predetermined number of chirp periods T, or a number of full rotations in azimuth by the optical scanner.

Lasers have inherent phase noise that places a limit on the precision of range measurements in FMCW LIDAR systems. The transmitted and received optical signals represented in FIG. 2 may be subject to unwanted variations in the phase, referred to herein as phase impairments or phase noise, which may be due to various types of causes. Among other things, variations in laser phase noises, circuitry phase noises, and flicker noises may be a source of higher-frequency phase impairments, while variations in the temperature of the LiDAR components may be a source of lower frequency phase impairments. Degradation of components over time may tend to create phase offsets to develop over time. Correcting for these phase impairments can help to achieve higher precision range measurements. Any of these types of phase impairment, among others, can be detected by LIDAR systems and compensated for using the techniques described herein.

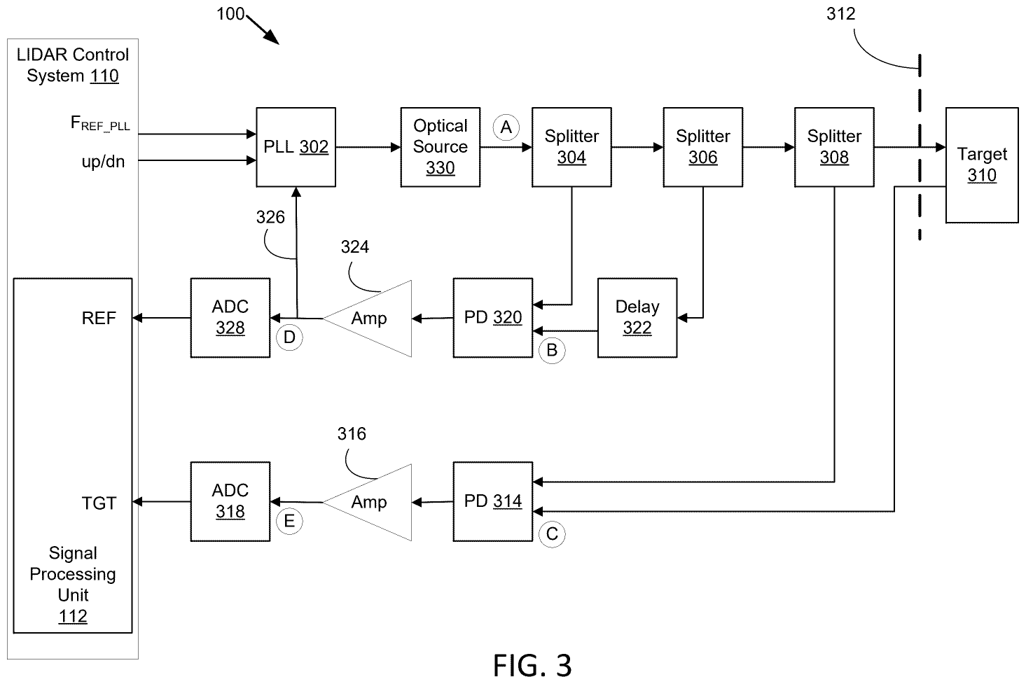

To correct these phase impairments, the LIDAR system 100 can split the laser output into two optical paths: one path (target path) sends the light to the target and the other path (reference path) sends the light into a reference delay spiral. The signal from the reference path can be used to estimate the phase noise, ϵ(t), which is used to correct the phase noise affecting the target signal. One embodiment of this technique is described further in relation to FIG. 3.

FIG. 3 is a block diagram of an example LIDAR system with phase noise correction, according to embodiments of the disclosure. The example LIDAR system 100 includes the LIDAR control system 110 and signal processing unit 112 described above in relation to FIG. 1. The LIDAR control system 110 is configured to control an optical source 330 (e.g., laser) to emit laser light in the form of chirped optical signals. In some embodiments, the optical signal may be a frequency-modulated continuous wave (FMCW) optical beam. It should be appreciated that in some scenarios, the optical signal output by the optical source 330 may be referred to herein as an outgoing, transmitted, or incident signal, while the signal reflected from the target 310 may be referred to herein as the incoming, received, or return signal.

The signal processing unit 112 is configured to receive a target signal, TGT, which is produced from the optical signals reflected from the target 310. The signal processing unit 112 processes the target signal to generate range and/or velocity data for the target as described above in relation to FIG. 2. The signal processing unit 112 also receives a reference signal (REF) used to estimate the phase noise present in the outgoing signal. This phase noise estimate may be used to cancel the phase noise from the target signal.

The LIDAR control system 110 may be configured to control the optical source 330 through a Phase-Locked Loop (PLL) 302. In the example shown in FIG. 3, the LIDAR control system 110 outputs a pair of PLL control signals (F_{REF_PLL} and up/dn) that drive the optical source 330 through the PLL 302. The control signal, F_{REF_PLL}, maintains the optical frequency of the optical source 300 at a desired frequency, and the control signal up/dn causes the frequency to increase or decrease to create up chirps or down chirps at the output of the optical source 330. The PLL 302 includes circuitry configured to maintain the frequency of the output optical signal at the desired frequency based on the detection of a feedback signal 326, which is the beat signal from the reference path. Specifically, the PLL 302 locks the beat signal from the reference path to the PLL reference frequency, F_{REF_PLL}, by continuously adjusting the laser current.

The outgoing optical signal passes through a series of splitters 304, 306, and 308 before exiting the LIDAR system 100 through window 312 and traveling to a target 310. The splitters 304, 306, and 308 are configured to redirect a portion of the outgoing signal to components within the LIDAR system 100 as described below. In the example shown in FIG. 3, splitter 304 and splitter 306 are configured to generate a reference signal, REF, and splitter 308 is used to generate a local oscillator (LO) signal for the optical signal returned from the target 310. It will be appreciated that the ordering of the splitters 304, 306, and 308 in relation to the outgoing signal is not a limiting feature of the present techniques. Additionally, the outgoing and return optical signals may also interact with or pass through any number of other optical components (e.g., lenses, filters, mirrors, scanning mirrors, etc.) for guiding optical signals within the LIDAR system.

The return signal reflected from the target 310 is directed to a photo detector 314. Additionally, the signal output by splitter 308 is used as a local oscillator (LO) signal, which is also directed to the photo detector 314. The time difference between the LO signal and the return signal generates a beat frequency, which is measured by the photodetector 314 and output as an electrical signal. The resulting electrical signal may be amplified by an amplifier 316 (e.g., transimpedance amplifier), converted to a digital signal by Analog to Digital Controller (ADC) 318, and then input to the LIDAR control system 110 as the target signal, TGT, which can be used to determine the distance to the target 310 as described above in relation to FIG. 2.

The reference signal, REF, may be generated using a portion of the output optical signal redirected by the splitters 304 and 306. For example, as shown in FIG. 3, the output of splitter 304 is used as an additional LO signal, which is input to a photodetector 320, and the output of splitter 306 is input to the same photodetector 320 after being delayed by an optical delay device 322. The optical delay device 322 may be a fiber delay device such as a fiber coil or spiral with a known length.

The time difference between the two signals received at photodetector 320 generates a beat frequency, which is measured by the photodetector 320 and output as an electrical signal. The resulting electrical signal is amplified by an amplifier 324, converted to a digital signal by Analog to Digital Controller (ADC) 328, and then input to the LIDAR control system 110, as the reference signal, REF. The output of the amplifier 328 may also be used as the feedback signal 326 for controlling the PLL 302.

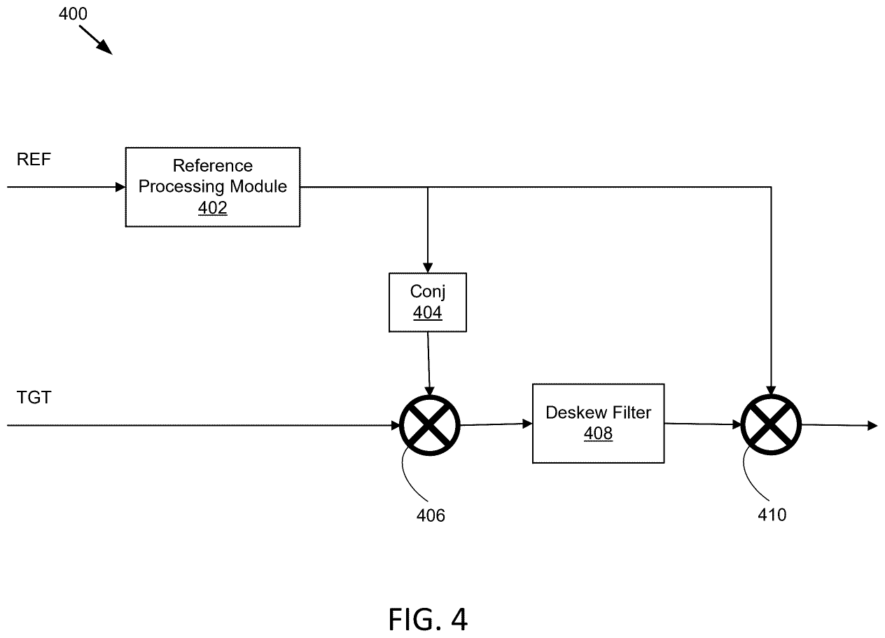

This digitally sampled reference signal, REF, has the same signature of phase noise as the received signal from the target, TGT. Accordingly, the signal processing unit 112 can process the reference signal to estimate the phase noise that exists both in the reference signal and the target signal. The phase noise estimate can be used to eliminate or reduce the phase noise present in the target signal, thereby improving the accuracy of the distance measurements. Techniques for correcting phase noise using the system of FIG. 3 are described further in relation to FIGS. 4-9. However, it will be appreciated that other techniques may exist and the various alterations may be made without deviating from the scope of the present disclosure.

FIG. 4 is a block diagram showing an example of a phase noise correction unit, according to embodiments of the disclosure. The phase noise correction unit 400 may be implemented in the signal processing unit 112 as hardware (e.g., microprocessors, logic circuits, etc.) or a combination of hardware and machine-readable instructions (e.g., software, firmware, etc.).

For the following description, various signals within LIDAR system 100 are labeled A through E as shown in FIG. 3. Signal A may be represented as γ(t)=exp{j2π(f_{c}t+0.5αt²+ϵ(t))} and is the outgoing optical signal output by optical source 330, which is the chirped optical signal at carrier frequency f_{C} and chirp rate a (=f_{REF}/τ_{REF}), and where ϵ(t) is the phase noise, which includes residual chirp error. Signal B may be represented as γ(t−τ_{REF}) and is the laser output delayed by reference spiral delay τ_{REF}, which is mixed with the LO from splitter 304 by the photodetector 320. Signal C may be represented as γ(t−τ_{TGT}) and is the laser output delayed by round-trip propagation delay to target τ_{TGT} and is mixed with the LO from splitter 308 by the photodetector 314. Signals A, B, and C, are optical signals. Optical signals B and C are converted to corresponding electrical signals D and E by the photodetectors 320 and 314 respectively.

The photodetectors 320 and 314 are square law devices such that Output=|γ(t)+γ(t−τ)|². Accordingly, the electrical reference signal output by photodetector 320 (Signal D) may be represented as r(t)=Cos{2π(f_{REF}t+ϵ(t)−ϵ(t−τ_{REF}))}. This electrical reference signal may be used for phase noise estimation and is digitized to generate the digital reference signal, REF. The target return signal output by photodetector 314 (Signal E) may be represented as q(t)=cos{2π(f_{TGT}t+ϵ(t)−ϵ(t−τ_{TGT}))}. This target return signal is used to estimate range and is digitized to generate the digital target signal, TGT. The frequency, f_{TGT}, is proportional to the propagation delay such that f_{TGT}=α·τ_{TGT}. The range to the target is given by

$${f}_{TGT} / ( \frac{2 α}{c} )$$

where

$$\frac{2 α}{c}$$

is known as the “tuning rate” (MHz/meter) and c is the speed of light. The reference signal, REF, and target signal, TGT, are time domain digital signals, and the signal processing described in relation to FIG. 4 may be performed in the time domain on these time domain signals.

As shown in FIG. 4, the reference signal, REF, is received by a reference processing module 402, which processes the reference signal digitally to compute an estimate of the phase noise term, ϵ(t). As noted above, the reference signal may be represented as r(t)=cos{2π(f_{REF}t+ϵ(t)−ϵ(t−τ_{REF}))}. To compute the estimate for ϵ(t), r(t) is down converted by f_{REF} and lowpass filtered to obtain exp{j2π((t)−ϵ(t−τ_{REF}))}. Next, the unwrapped phase of the complex waveform is computed to obtain D(t)=ϵ(t)−ϵ(t−τ_{REF}). If the reference time delay, τ_{REF}, is sufficiently small, then the instantaneous rate of change of the phase noise term, ϵ(t), is approximately equal to the unwrapped phase divided by the reference time delay, which may be represented as:

$$\frac{D ( t )}{{τ}_{REF}} = \frac{ϵ ( t ) - ϵ ( t - {τ}_{REF} )}{{τ}_{REF}} \approx \frac{d ϵ}{dt} ( t ) .$$

Accordingly, the reference processing module 402 can compute an estimate for the phase noise by integrating the unwrapped phase using the following:

$$\hat{ϵ} ( t ) = \frac{1}{{τ}_{REF}} {\int }_{- ∞}^{t} D ( λ ) d λ$$

In the above equation, \hat{ϵ} (t) represents the estimate of the actual phase noise, ϵ(t), present in the reference signal, r(t). This phase noise estimate may also be represented as:

$${s}_{\hat{ϵ}} ( t ) = {e}^{+ j 2 π \hat{ϵ} ( t )}$$

The estimate computed for \hat{ϵ} (t) using the reference signal, REF, may then be used to determine a phase correction for the target signal, TGT. For the sake of simplicity of exposition, it assumed that \hat{ϵ} (t)=ϵ(t). As stated above, the target signal is given by: q(t)=cos{2π(f_{TGT}t+ϵ(t)−ϵ(t−τ_{TGT}))}. An estimate for f_{TGT} can be used to determine the range to the target, but the presence of the phase noise terms will degrade the quality of the estimate. The phase noise estimate computed by the reference processing module 402 is used to correct the phase noise on the positive frequency component of q(t), denoted q+ (t). In the process, the phase noise on the negative frequency component of q(t) will be made far worse. However, in most cases, the negative component is not used and the range is computed from the positive component. The positive frequency component of q(t) is given by:

$${q}_{+} ( t ) = {e}^{+ j 2 πϵ ( t )} \cdot {e}^{- j 2 πϵ ( t - {τ}_{TGT} )} \cdot {e}^{+ j 2 π {f}_{TGT} t} = {s}_{ϵ}^{*} ( t - {τ}_{TGT} ) \cdot {e}^{+ j 2 π {f}_{TGT} t}$$

Since s_{ϵ}(t) is known, it is possible to compute the complex conjugate of s_{ϵ}(t), denoted s_{ϵ}*(t) and cancel out a portion of the phase noise by multiplication. As shown in FIG. 4, the phase noise estimate s_{ϵ}(t) is output from the reference processing module 402 to the conjugate module 404, which computes the complex conjugate, s_{ϵ}*(t) and sends it to the multiplier 406 to be multiplied by the target signal, TGT. The resulting signal output by the multiplier 406 may be represented as follows:

$${s}_{ϵ}^{*} ( t ) \cdot {q}_{+} ( t ) = {s}_{ϵ}^{*} ( t - {τ}_{TGT} ) \cdot {e}^{j 2 π {f}_{TGT} t}$$

In the above formula, s_{ϵ}*(t−τ_{TGT}) is a remaining phase noise term present in the partially corrected signal. The remaining phase noise term has a dependency on τ_{TGT} which is the round-trip time to the target. In some embodiments, the remaining phase noise term may be compensated by a deskew filter 406, which is a filter with a controlled group delay and flat magnitude response. The deskew filter 406 may be a finite impulse response (FIR) filter of any suitable order, N, and may be designed to have a negative group delay with a linear slope that is

$$( Group Delay = - \frac{1}{α} ) ,$$

inversely proportional to the chirp rate of the outgoing optical beam where a is the chirp rate. If s_{ϵ}*(t−τ_{TGT})·e^{j2πf}^{_{TGT}}^{t} is a narrowband signal concentrated near f_{TGT}, then the effect of passing it through a deskew filter 408 with the above group delay will be to advance in time in time by τ_{TGT}. Accordingly, the output of the deskew filter 408 will be s_{ϵ}*(t)·e^{j2πf}^{_{TGT}}^{(t+τ}^{_{TGT}}⁾. The output of the deskew filter 408 may then be multiplied by s_{ϵ}(t) at multiplier 410 to obtain a phase noise free signal: e^{j2πf}^{_{TGT}}^{(t+τ}^{_{TGT}}⁾. The noise free signal may then be sent to a next processing stage, which may vary depending on the details of a specific implementation.

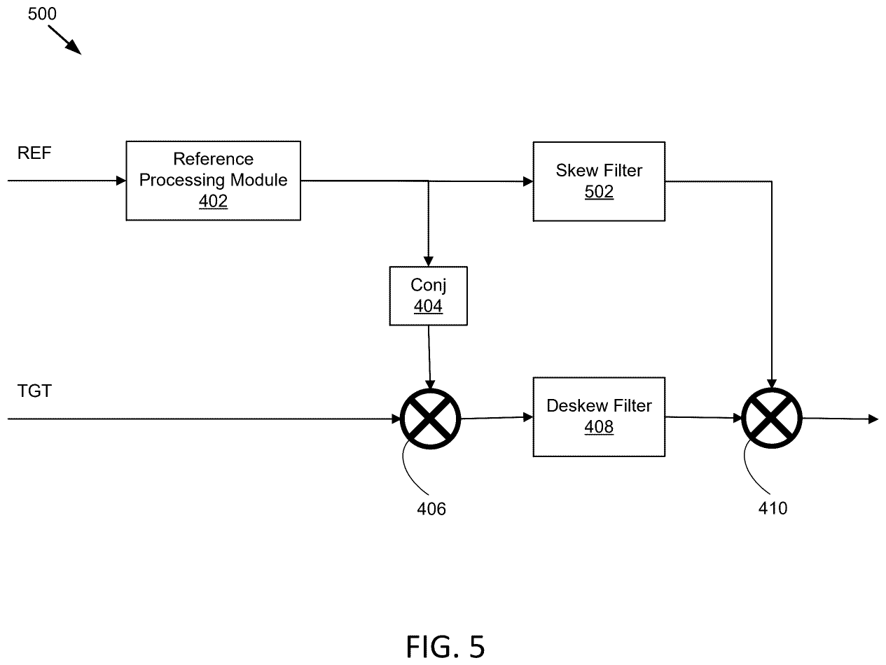

As stated above, the phase correction technique shown in FIG. 4 may be more effective in cases the partially corrected signal, s_{ϵ}*(t−τ_{TGT})·e^{j2πf}^{_{TGT}}^{t}, is a narrowband signal concentrated near f_{TGT}. In cases where the partially corrected signal is not narrowband, the phase correction techniques described in relation to FIG. 5 may be used.

FIG. 5 is a block diagram showing another example of a phase noise correction unit, according to embodiments of the disclosure. The phase noise correction unit 500 may be implemented in the signal processing unit 112 as hardware (e.g., microprocessors, logic circuits, etc.) or a combination of hardware and machine-readable instructions (e.g., software, firmware, etc.). The phase noise correction unit 500 is similar to the phase noise correction unit 400 of FIG. 4 and includes the reference processing module 402, the conjugate module 404, and the deskew filter 406, which operate as described above.

As described in relation to FIG. 4, the deskew filter 408 receives the partially corrected signal s_{ϵ}*(t−τ_{TGT})e^{+j2πf}^{_{TGT}}^{t}. The deskew filter 408 will cause the portion of the phase noise near f_{TGT} to be advanced in time correctly. However, signals away from f_{TGT} will not. For example, some portions of the spectrum may be insufficiently advanced or even delayed compared to the portions of the spectrum near f_{TGT}. In this case, multiplying the partially corrected signal by s_{ϵ}(t) as described in FIG. 4 will not adequately cancel the phase noise away from f_{TGT} and leave some residual error.

To address this, the phase noise correction unit 500 includes a skew filter 502. In this embodiment, the phase noise estimate, s_{ϵ}(t), generated by the reference processing module 402 is passed through the skew filter 502 before being multiplied by the output of the deskew filter 408. The skew filter 502 compensates the phase noise estimate by delaying portions of the spectrum by the appropriate amount to match the delays in the partially corrected signal output by the deskew filter. In some embodiments, this skew filter 502 may be designed to have a linear group delay with linear slope that is inversely proportional to a chirp rate of the outgoing optical beam

$$( Group Delay = + \frac{1}{α} )$$

(microseconds/MHz) so that the output of the skew filter 502 will be s_{ϵ}(t−τ_{TGT}). The output of the deskew filter 408 and the output of the skew filter 510 are mixed at multiplier 410 to obtain a phase noise free signal. The noise free signal may then be sent to a next processing stage, which may vary depending on the details of a specific implementation.

Both the skew filter 502 and the deskew filter 408 may be discrete-time FIR filters. For each filter 408 and 502, the desired filter response (also referred to as impulse response) may be determined during operation of the FMCW system based on the frequency range of the optical signals and the chirp rate. The desired filter response may be implemented by determining the values of the filter coefficients that can achieve the desired filter response. The frequency and chirp rate may be adjustable features that can be selected by the human operator of the LIDAR system or may be adjusted automatically based on operating conditions. Accordingly, new filter coefficients may be computed and used during operation of the LIDAR system in response to changes in the chirp rate or operating frequency, for example.

The deskew filter 408 may be configured to exhibit a filter response, H(f), with quadratic phase and unit magnitude: H(f)=e^{+jπf}^{²}^{/α}. The unwrapped phase of this response is <H(f)=πf²/α. The definition of group delay is

$$- \frac{1}{2 π} \frac{d∠H ( f )}{df} .$$

Accordingly, the group delay of the deskew filter 408 has a linear slope of

$$- \frac{1}{2 π} \cdot \frac{d∠H ( f )}{df} = - \frac{f}{α} ,$$

which means that the slope is the negative inverse of the chirp rate

$$( Group Delay Slope = - \frac{1}{α} ) .$$

The skew filter 502 may be configured to exhibit a filter response that is the complex conjugate of the deskew filter response: H*(f)=e^{-jπf}^{²}^{/α}. Accordingly, the group delay of the skew filter 502 will have a linear slope of

$$- \frac{1}{2 π} \cdot \frac{d∠H ( f )}{df} = - \frac{f}{α} ,$$

which means that the slope is the positive inverse of the chirp rate

$$( Group Delay Slope = + \frac{1}{α} ) .$$

To implement the deskew filter 408 in discrete time, filter coefficients are obtained for the desired filter response. Any suitable technique for determining the filter coefficients may be used, and the disclosed techniques are not limited to the specific examples described herein. In some embodiments, a frequency-domain sampling technique may be used to obtain the filter coefficients. In this technique, a sampling frequency Fₛ is chosen and the desired deskew filter response is sampled over N frequency domain points, kFₛ/N, from −Fₛ/2 to Fₛ/2, which gives the result:

$${H}_{k} = H ( {kF}_{s} / N ) = {e}^{+ j {π ( {kF}_{s} / N )}^{2} / α} for - \frac{N}{2} \leq k < \frac{N}{2}$$

In the above equation, Hₖ, represents the frequency-domain filter coefficients. In some embodiments, the deskew filter 408 may be implemented in the frequency domain by generating an N-point FFT of the input signal, multiplying the resulting frequency domain signal by these filter coefficients, and then taking an N-point Inverse FFT (IFFT) to transform the signal back to a time domain signal, a process known as circular convolution. In this example, the input and output of the deskew filter 408 are both in the time domain. However, the phase noise cancellation is still performed in the time domain.

In some embodiments, the deskew filter 408 may be implemented in the time domain using a Finite Impulse Response (FIR) filter by generating the IFFT of the frequency-domain filter coefficients, Hₖ, and applying a window in the time domain. In some embodiments, the time domain filter coefficients for the FIR filters can be automatically generated using a tool called an FIR compiler. This avoids lengthy design time and results in FIR filters that have optimized implementations that are not too long. Since multiplication in the frequency domain is equivalent to convolution in the time domain, the FIR-based (time-domain) architecture may involve more multiplications than FFT/IFFT (frequency domain) based architecture. However, at lower sampling rates, the time duration of the deskew filter 408 will be reduced considerably.

The coefficients for the time-domain FIR deskew filter 408 may have complex coefficients {hₙ} and complex input data {xₙ}. In some embodiments, the fact that the filter coefficients are symmetric may be used to halve the number of multiplications. The number of real multiplications can be further reduced using just three real multiplications (shown below) to multiply two complex numbers instead of four.

$$\begin{matrix}C = real ( h ) \cdot ( real ( x ) + imag ( x ) ) \\ real ( h \cdot x ) = C - ( real ( h ) + img ( h ) \cdot imag ( x ) \\ imag ( h \cdot x ) = C - ( real ( h ) - imag ( h ) ) \cdot real ( x )\end{matrix}$$

It will be appreciated that various other techniques for reducing the number of multiplications may be implemented in accordance with embodiments of the present techniques. The skew filter 502 may be implemented using the same techniques as described above but designed to produce a different group delay.

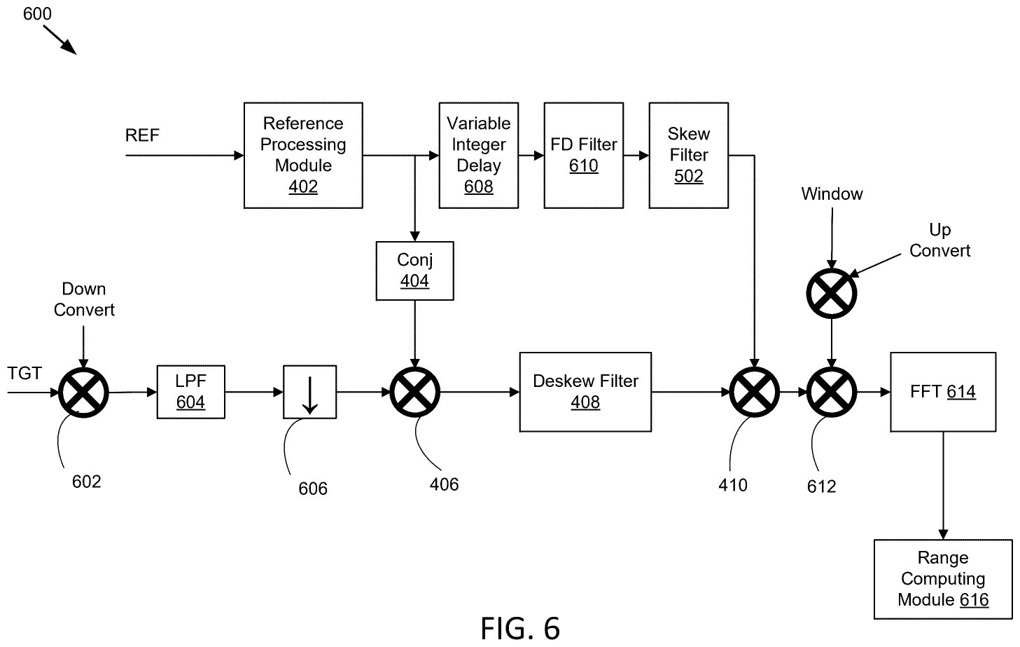

FIG. 6 is a block diagram showing another example of a phase noise correction unit, according to embodiments of the disclosure. The phase noise correction unit 600 is similar to the phase noise correction unit 500 of FIG. 5 and includes the reference processing module 402, the conjugate module 404, the deskew filter 406, and the skew filter 502, which operate as described above. FIG. 6 describes one embodiment of a technique for implementing a phase noise correction in a system that also uses down conversion and down sampling.

Analog or digital down-conversion can be used to shift the portion of the spectrum that will be processed by the signal processing unit 112 to a lower frequency range. For example, if the LIDAR system is optimized to provide range estimates from 0 meters to 10 meters, and the target is estimated to be approximately 15 meters away, the spectrum of the received signal can be shifted by the equivalent of 10 meters so that the signal processing unit 112 will now be able to process targets from 10 meters to 20 meters. In the example shown in FIG. 6, the target signal, TGT, is a digital signal, which is digitally down converted to a lower frequency using a multiplier 602 and then passed through a low pass filter 604. In analog down-conversion, the target signal, TGT, would be down-converted using analog down-conversion, then the low pass filter 604 (which would be an analog filter), would be followed by an analog-to-digital converter. The filtered digital signal passes through downsampling unit 606 which reduces the sampling rate of the signal by keeping every M^{th} sample. Reducing the sampling rate reduces the complexity of the and the power consumption of the subsequent circuits.

In the embodiment shown in FIG. 6, the amount of down-conversion is taken into account when determining the phase noise correction. For example, the amount of down conversion may be used to alter the filter coefficients of the skew filter 502, the deskew filter 408, or both. The filter coefficients may be re-computed based on the amount of frequency shift caused by the down conversion, denoted as F_{dc}.

In some embodiments, the skew filter 502 stays the same and the deskew filter 408 is changed. Specifically, if the target path is down-converted by Fac MHz, the deskew coefficients, Dₖ, may be changed to:

$${D}_{k} = exp ( + j π \frac{{( k / N + {F}_{dc} / {F}_{s} )}^{2}}{A} ) ,$$

where:
N is the FFT size;
k is the FFT bin index (from −N/2 to N/2−1);
Fₛ is the original sampling rate used by the signal processing unit

$$A = α / {( {F}_{s} )}^{2} .$$

In this embodiment, the skew filter coefficients in the reference path will remain as:

$${S}_{k} = exp ( - j π \frac{{( k / N )}^{2}}{A} )$$

In other embodiments, the deskew filter 408 stays the same and the skew filter 502 is changed. Specifically, if the target path is down-converted by Fac MHz, the skew coefficients, Sₖ, may be changed to:

$${S}_{k} = exp ( - j π \frac{{( k / N + {F}_{dc} / {F}_{s} )}^{2}}{A} )$$

In this embodiment, the deskew filter coefficients in the target path will remain as:

$${D}_{k} = exp ( + j π \frac{{( k / N )}^{2}}{A} )$$

In the embodiment shown in FIG. 6, the deskew filter 408 and the skew filter 502 both remain the same and the spectrum of the phase noise estimate is further delayed using a variable integer delay 608 and a fractional delay (FD) filter 610. The variable integer delay 608 and a fractional delay filter 610 are designed based on the amount of down conversion.

Expanding the above expression for the new skew coefficients yields:

$${S}_{k} = exp ( - j π \frac{{( k / N )}^{2}}{A} ) exp ( - j \frac{2 π}{N} k \cdot \frac{{F}_{dc} / {F}_{s}}{A} ) exp ( - j π \frac{{( {F}_{dc} / {F}_{s} )}^{2}}{A} )$$

The first term is the original skew coefficient, the second term includes an integer delay and fractional delay, and the last term is a phase shift, which can be ignored. The amount of delay is given by τ_{dc}=F_{dc}/α microseconds, which can be broken up into an integer number of samples equal to [Fₛ·τ_{dc}] (brackets indicate rounding to the nearest integer) and a fractional of a sample Fₛ·τ_{dc}−[Fₛ·τ_{dc}], which will be a number between −0.5 and 0.5. The integer number is the number of samples of delay that will be implemented by the variable integer delay 608. The fraction of a sample is used to determine filter coefficients for the fractional delay filter 610. Together, the variable integer delay 608, a fractional delay filter 610, and the skew filter 502 provide the same filter response that would be provided if the skew filter 502 coefficients were changed instead. However, the variable integer delay 608, the fractional delay filter 610, are relatively simple components that may be more easily adjustable compared to the skew filter 502. For example, the skew filter 502 may have around one hundred or more taps, whereas the fractional delay filter 610 may be implemented in less than 20 taps.

The output of the deskew filter 408 and the output of the skew filter 510 are mixed at multiplier 410 to obtain a target signal that is free of phase noise. In some embodiments, the target signal may then be upconverted back to the original frequency at multiplier 612 to undo the down conversion applied at multiplier 602. The upconverted signal may also be processed by an FFT module 614 to transform the time domain signal to a frequency domain signal. The frequency domain signal may then be processed by the range computing module 616, which computes range information from the signal in addition to other possible information such as velocity. The specific techniques for processing the signal may vary depending on the details of a specific implementation. For example, the range computing module 616 may include a peak picker that identifies peaks in the frequency domain signal, which indicate the frequency difference for the return signal. The range computing module 616 may also include an interpolator (e.g., parabolic interpolator) that is used to identify the position of true peaks as opposed to peaks caused by aliasing or ghosting, for example. The range computing module 616 may also include a point processor that computes the range information, which can be combined with orientation information from the scanning circuitry to identify specific points in three-dimensional space.

It will be appreciated that the system of FIG. 6 may include additional components or fewer components and that various modifications may be made without deviating from the scope of the present disclosure. For example, the signal processing system 112 may include signal amplifiers, filters, buffers, and other signal processing circuitry not shown in FIG. 6 for the sake of clarity.

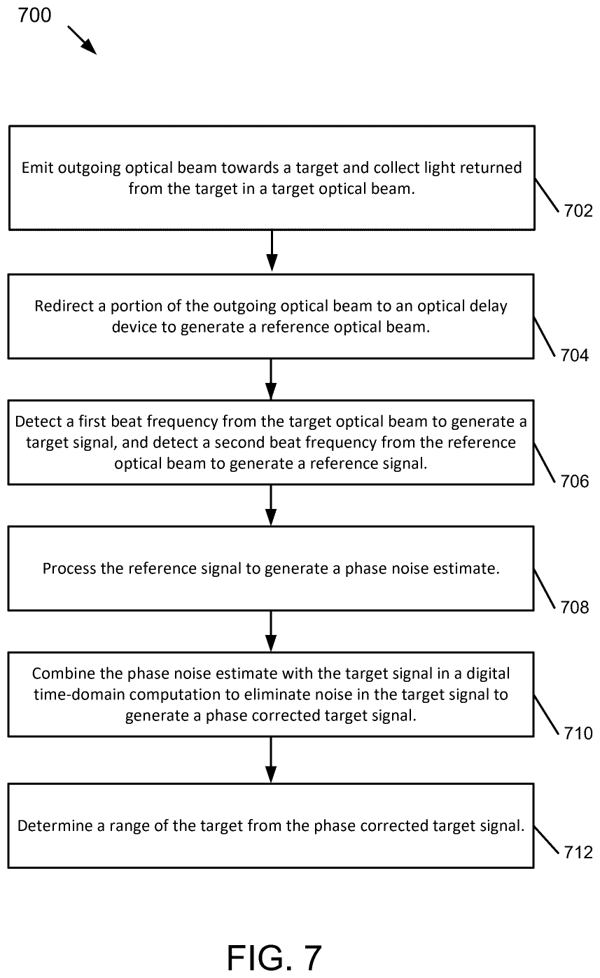

FIG. 7 is a process flow diagram summarizing a method for eliminating phase noise from signals used to measure range, according to an embodiment of the present disclosure. The method 700 may be performed by any suitable LiDAR system, including the LiDAR system 100 of FIGS. 1 and 3, which may include any of the phase noise correction units 400, 500, 600, described herein and combinations thereof. The method may begin at block 702.

At block 702, an outgoing optical beam is emitted towards a target and light returned from the target collected in a target optical beam.

At block 704, a portion of the outgoing optical beam is redirected to an optical delay device to generate a reference optical beam.

At block 706, a first beat frequency is detected from the target optical beam to generate a target signal, and a second beat frequency is detected from the reference optical beam to generate a reference signal.

At block 708, the reference signal is processed to generate a phase noise estimate.

At block 710, the phase noise estimate is combined with the target signal in a digital time-domain computation to eliminate noise in the target signal to generate a phase corrected target signal. The phase noise estimate is combined with the target signal in such a way that the phase noise is canceled from the target signal. Combining the phase noise estimate with the target signal also includes combining the phase noise estimate with the target signal more than once, as shown for example in FIG. 4-6.

At block 712, a range of the target is determined from the phase corrected target signal.

It will be appreciated that embodiments of the method 700 may include additional blocks not shown in FIG. 7 and that some of the blocks shown in FIG. 7 may be omitted. Additionally, the processes associated with blocks 702 through 712 may be performed in a different order than what is shown in FIG. 7.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

Although the operations of the methods herein are shown and described in a particular order, the order of the operations of each method may be altered so that certain operations may be performed in an inverse order or so that certain operations may be performed, at least in part, concurrently with other operations. Instructions or sub-operations of distinct operations may be performed in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A light detection and ranging (LiDAR) system, comprising:
an optical arrangement configured to emit an outgoing optical beam towards a target and collect light returned from the target in a target optical beam;
an optical splitter to redirect a portion of the outgoing optical beam to an optical delay device to generate a reference optical beam;
a first optical receiver to detect a first beat frequency from the target optical beam to generate a target signal;
a second optical receiver to detect a second beat frequency from the reference optical beam to generate a reference signal; and
a signal processing system to process the target signal and the reference signal to eliminate phase noise in the target signal, the signal processing system to:
process the reference signal to generate a phase noise estimate and combine the phase noise estimate with the target signal in a digital time-domain computation to eliminate noise in the target signal to generate a phase corrected target signal; and
determine a range of the target from the phase corrected target signal.

2. The LiDAR system of claim 1, further comprising:
a down converter to reduce a frequency range of the target signal, wherein to combine the phase noise estimate with the target signal comprises to add a time delay to the phase noise estimate, wherein the time delay is determined based on an amount of frequency reduction caused by the down converter.

3. The LiDAR system of claim 1, wherein to combine the phase noise estimate with the target signal, the signal processing system to:
combine a complex conjugate of the phase noise estimate with the target signal to generate a partially corrected signal;
pass the partially corrected signal through a deskew filter; and
combine the phase noise estimate with an output of the deskew filter to generate the phase corrected target signal.

4. The LiDAR system of claim 3, wherein a filter response of the deskew filter is configured to provide a negative group delay with a linear slope inversely proportional to a chirp rate of the outgoing optical beam.

5. The LiDAR system of claim 3, wherein filter coefficients of the deskew filter are computed to generate a specified filter response based on an operating frequency and chirp rate of the outgoing optical beam.

6. The LiDAR system of claim 3, wherein the deskew filter is a time-domain Finite Impulse Response (FIR) filter.

7. The LiDAR system of claim 1, wherein to combine the phase noise estimate with the target signal, the signal processing system to:
combine a complex conjugate of the phase noise estimate with the target signal to generate a partially corrected signal;
pass the phase noise estimate through a skew filter to generate a time-delayed phase noise estimate; and
combine the time-delayed phase noise estimate with the partially corrected signal to generate the phase corrected target signal.

8. The LiDAR system of claim 7, wherein a filter response of the skew filter is configured to provide a positive group delay with a linear slope inversely proportional to a chirp rate of the outgoing optical beam.

9. The LiDAR system of claim 7, wherein the skew filter is a time-domain Finite Impulse Response (FIR) filter.

10. A method of light detection and ranging (LiDAR), comprising:
emitting an outgoing optical beam towards a target and collecting light returned from the target in a target optical beam;
redirecting a portion of the outgoing optical beam to an optical delay device to generate a reference optical beam;
detecting a first beat frequency from the target optical beam to generate a target signal, and detecting a second beat frequency from the reference optical beam to generate a reference signal;
processing the reference signal to generate a phase noise estimate;
combining the phase noise estimate with the target signal in a digital time-domain computation to eliminate noise in the target signal to generate a phase corrected target signal; and
determining a range of the target from the phase corrected target signal.

11. The method of claim 10, further comprising:
reducing a frequency range of the target signal, wherein combining the phase noise estimate with the target signal comprises adding a time delay to the phase noise estimate, wherein the time delay is determined based on an amount that the frequency range is reduced.

12. The method of claim 10, wherein combining the phase noise estimate with the target signal, comprises:
combining a complex conjugate of the phase noise estimate with the target signal to generate a partially corrected signal;
passing the partially corrected signal through a deskew filter; and
combining the phase noise estimate with an output of the deskew filter to generate the phase corrected target signal.

13. The method of claim 12, wherein a filter response of the deskew filter is configured to provide a negative group delay with a linear slope inversely proportional to a chirp rate of the outgoing optical beam.

14. The method of claim 12, further comprising computing filter coefficients of the deskew filter to generate a specified filter response based on an operating frequency and chirp rate of the outgoing optical beam.

15. The method of claim 12, wherein the deskew filter is a time-domain Finite Impulse Response (FIR) filter.

16. The method of claim 10, wherein to combine the phase noise estimate with the target signal comprises:
combining a complex conjugate of the phase noise estimate with the target signal to generate a partially corrected signal;
passing the phase noise estimate through a skew filter to generate a time-delayed phase noise estimate; and
combining the time-delayed phase noise estimate with the partially corrected signal to generate the phase corrected target signal.

17. The method of claim 16, wherein a filter response of the skew filter is configured to provide a positive group delay with a linear slope inversely proportional to a chirp rate of the outgoing optical beam.

18. The method of claim 16, wherein the deskew filter is a time-domain Finite Impulse Response (FIR) filter.

19. A frequency modulated continuous wave (FMCW) light detection and ranging (LIDAR) system, comprising:
a processing device; and
a memory to store instructions that, when executed by the processing device, cause the LIDAR system to:
emit an outgoing optical beam towards a target and collect light returned from the target in a target optical beam;
redirect a portion of the outgoing optical beam to an optical delay device to generate a reference optical beam;
detect a first beat frequency from the target optical beam to generate a target signal, and detect a second beat frequency from the reference optical beam to generate a reference signal;
process the reference signal to generate a phase noise estimate;
combine the phase noise estimate with the target signal in a digital time-domain computation to eliminate noise in the target signal to generate a phase corrected target signal; and
determine a range of the target from the phase corrected target signal.

20. The LIDAR system of claim 19, the memory further comprising instructions cause the LIDAR system to:
reduce a frequency range of the target signal, wherein to combine the phase noise estimate with the target signal comprises to add a time delay to the phase noise estimate, wherein the time delay is determined based on an amount that the frequency range is reduced.

21. The LIDAR system of claim 19, wherein to combine the phase noise estimate with the target signal, comprises to:
combine a complex conjugate of the phase noise estimate with the target signal to generate a partially corrected signal;
pass the partially corrected signal through a deskew filter; and
combine the phase noise estimate with an output of the deskew filter to generate the phase corrected target signal.

22. The LIDAR system of claim 21, wherein a filter response of the deskew filter is configured to provide a negative group delay with a linear slope inversely proportional to a chirp rate of the outgoing optical beam.

23. The LIDAR system of claim 21, the memory further comprising instructions cause the LIDAR system to:
compute filter coefficients of the deskew filter to generate a specified filter response based on an operating frequency and chirp rate of the outgoing optical beam.

24. The LiDAR system of claim 19, wherein to combine the phase noise estimate with the target signal comprises to:
combine a complex conjugate of the phase noise estimate with the target signal to generate a partially corrected signal;
pass the partially corrected signal through a deskew filter;
pass the phase noise estimate through a skew filter to generate a time-delayed phase noise estimate; and
combine the time-delayed phase noise estimate with an output of the deskew filter to generate the phase corrected target signal.

25. The LiDAR system of claim 24, wherein the skew filter and the deskew filter are time-domain Finite Impulse Response (FIR) filters.
